(19) United States
(12) Patent Application Publication
(10) Pub. No.: US 2005/0098049 A1
(43) Pub. Date: May 12, 2005

(54) Screw compactor

(76) Inventor: Nigel R C Shepherd, Ross-on-Wye (GB)

Correspondence Address: NIELDS & LEMACK, 176 EAST MAIN STREET, SUITE 7, WESTBORO, MA, 01581, US

(21) Appl. No.: 10/980,017

(22) Filed: Nov. 3, 2004

(30) Foreign Application Priority Data
Nov. 12, 2003 (GB) 03 26 372.0

(51) Int. Cl. B30B 9/12

(52) U.S. Cl. 100/117; 100/38; 100/126; 100/337; 100/145

(57) ABSTRACT

A screw compactor comprising a housing (4) having an opening for the insertion of wet waste to be compacted and defining a compaction volume (14); a screw (8) rotatably mounted in the housing; a guideway for transporting compacted waste from the compaction volume; a motor (10) for rotating the screw; and a duct (20) to pass air heated by the motor (10) to the guideway to heat the compacted waste. The heating of the compacted waste reduced the liquid content in the compacted waste by enhancing evaporation.

This application claims priority of Great Britian Patent Application No. 03 26 372.0 filed on Nov. 12, 2003, the disclosure of which is incorporated herein by reference.

The present invention relates to screw compactors having a housing having an opening for the insertion of wet waste to be compacted and defining a compaction volume; a screw rotatably mounted in the housing; a guideway for transporting compacted waste from the compaction volume; and a motor for rotating the screw.

In such compactors the screw is rotated thereby transporting the waste to and forcing it into the compaction volume. The drag forces exerted by the waste on the side walls of housing including the compaction volume cause the waste to be compacted due to the force exerted on the waste by the screw.

The compacting of the waste causes excess liquid to be squeezed out of the waste material which can exit the housing through-holes in the side walls. The compacted waste exiting the compaction volume is urged along the guideway towards a depositary for the waste, eg a collection bin.

The purpose of the compaction is to remove the liquid from the initial wet waste material to reduce the volume and weight of the collected waste material and to make the waste material more suitable for incineration, if that is the eventual route of disposal.

The present invention seeks to provide a screw compactor which can remove an increased amount of liquid during its treatment by the compactor apparatus.

Accordingly, the present invention provides a screw compactor of the type described above and further comprising a duct arranged to pass air heated by the motor to the vicinity of the guideway to heat the compacted waste.

The heating of the waste material during treatment by the compactor apparatus provides additional liquid removal due to enhanced evaporation.

Conveniently, the duct is defined, at least in part, by the housing, compactor and guideway, for example by a cover disposed over them, but other configurations of duct may be employed.

A fan may be used to induce the passage of the air heated by the motor to the guideway via the duct, for example a built-in cooling fan of the motor.

The lower extents of any part of or all of the compactor housing, compactor volume and guideway may have apertures to permit the free exit of liquid squeezed from the waste material during compaction and transport on the guideway. These regions may be made from metal mesh, for example.

To enhance evaporation further, the guideway may be in thermal contact with a heating element to heat the guideway and so the waste material transported by it.

The present invention also encompasses a method of treating compacted waste compacted by a screw compactor, comprising heating the compacted waste with air heated, at least partially, by the heat of a motor driving the screw of the screw compactor.

The method, optionally, may include inducing air flow over the motor and through the duct by means of a fan, conveniently the fan driven by the motor. The method may also include guiding the waste material away from the compactor by a heated guideway.

Embodiments of the invention will now be described, by way of example only, with reference to the accompanying drawings, of which:

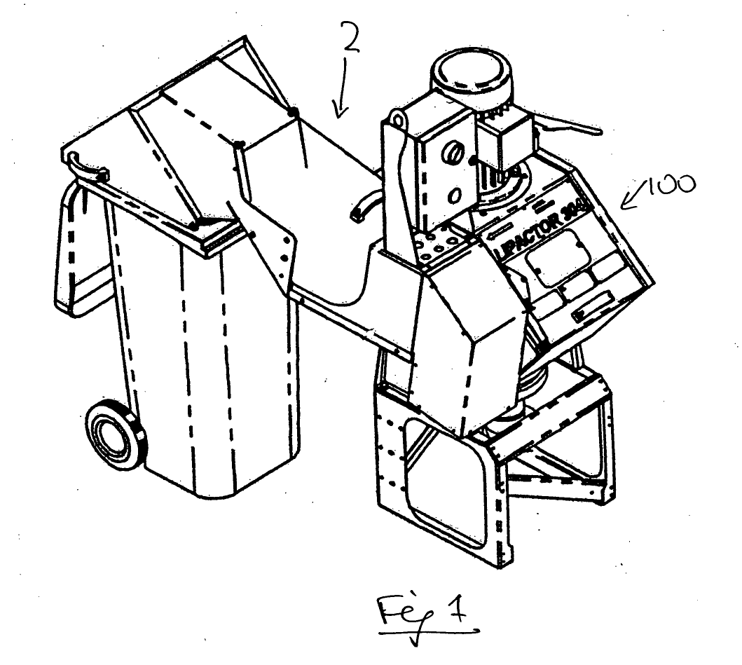

FIG. 1 is a diagrammatic perspective view of a screw compactor according to the present invention;

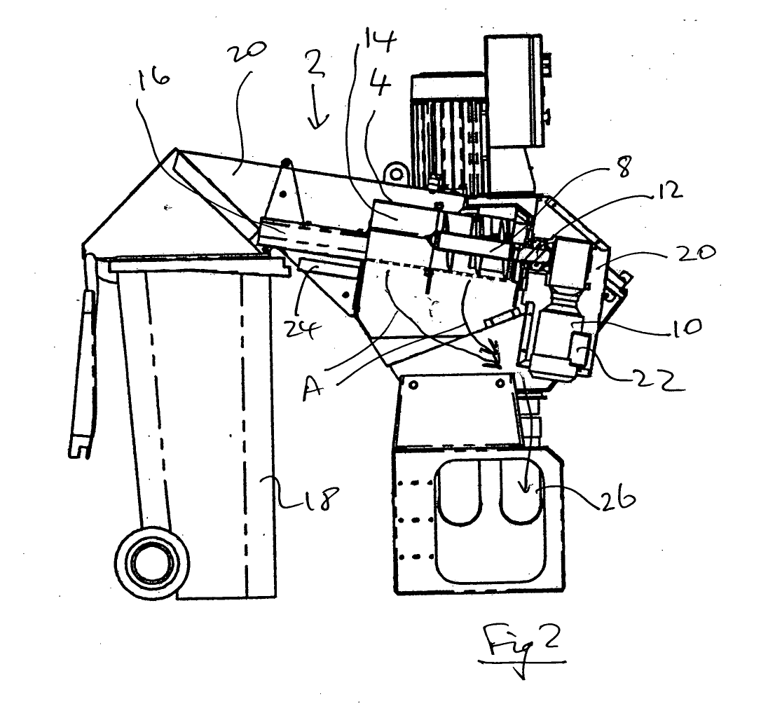

FIG. 2 is a diagrammatic part-sectional side view of the compactor of FIG. 1; and

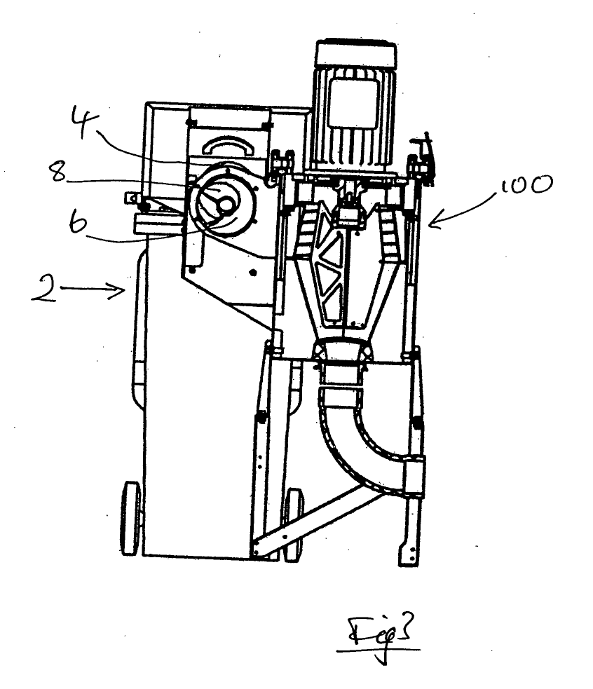

FIG. 3 is a diagrammatic part-sectional end view of the compactor of FIG. 1.

Referring to the Figures, a screw compactor includes a cylindrical housing 4 having an opening 6 for the insertion of wet waste, in this embodiment from a liquid separator 100.

The housing includes a compactor screw 8 rotatably mounted in the housing 4 and rotatable by a ¼ kw electric motor 10 via a drive shaft 12. The housing 4 further defines a cylindrical compaction volume 14.

A stainless steel 3 mm mesh guideway 16 extends from the compaction volume 14 to a collection bin 18 for receiving the compacted waste material.

The motor lies within a duct 20 which extends over the screw compactor housing 4, and guideway 14 and is partially defined by them. The motor 10 has a cooling fan 22 driven by the motor 10.

Waste material entering the screw compactor is compacted in known manner, as described earlier, by the action of the rotating screw and the frictional interaction of the waste with the walls of the housing 4 and in particular at the compactor volume 14.

Liquid squeezed from the waste during this compaction process exits the housing 4 via apertures 24 in the lower region of the housing as indicated by flow paths A to a liquid exit conduit 26.

Compacted waste material is urged along the guideway by the action of the rotating screw 8 to the waste collection bin 18.

Additionally, and in accordance with the present invention, the fan 22 induces a air flow over the motor 10, which heats the air, and over the housing 4, and the waste that is on the guideway 16 thereby heating the waste an enhancing evaporation from the waste material.

A thermal pad 24, heated by an electric element, is also employed in this embodiment to heat the guideway 16 and so provide additional heating of the compacted waste material.

Typically, waste material having about a 60% water content and solids under 3 mm will have a water content of about 30 to 40% after processing by the apparatus and method of the present invention.

1. A screw compactor comprising:
a housing having an opening for the insertion of wet waste to be compacted and defining a compaction volume;
a screw rotatably mounted in the housing;
a guideway for transporting compacted waste from the compaction volume;
a motor for rotating the screw; and
a duct to pass air heated by the motor to the vicinity of the guideway to heat the compacted waste.

2. The screw compactor of claim 1 in which the duct is defined, in at least part, by the housing and guideway.

3. The screw compactor of claim 1, in which there is a fan for inducing the passage of the air heated by the motor to the guideway.

4. The screw compactor of claim 3, in which the fan is part of the motor.

5. The screw compactor of claim 1, in which the housing has mesh walls, at least in part.

6. The screw compactor of claim 1 in which the guideway is in thermal contact with a heating element.

7. A method of treating compacted waste compacted by a screw compactor, comprising heating the compacted waste with air heated, at least partially, by the heat of a motor driving the screw of the screw compactor.

8. The method of claim 7, including inducing air flow over the motor by means of a fan.

9. The method of claim 8, in which the fan is driven by the motor.

10. The method of claim 7, in which the compacted waste is guided away from the compactor by a heated guideway.
